(19) United States
(12) Patent Application Publication
(10) Pub. No.: US 2018/0182257 A1
(43) Pub. Date: Jun. 28, 2018

(54) SYSTEM FOR MANAGING GOALS

(71) Applicant: LAI RAM SANG, GREER, SC (US)

(72) Inventor: LAI RAM SANG, GREER, SC (US)

(21) Appl. No.: 15/392,130

(22) Filed: Dec. 28, 2016

(51) Int. Cl. G09B 19/00; G06F 3/0488; G06F 3/0482; G09B 5/02

(52) U.S. Cl. CPC G09B 19/00; G09B 5/02; G06F 3/0482; G06F 3/0488

(57) ABSTRACT

A system for enabling a number of users to manage a number of lifestyle, personal and professional development related tasks to achieve one or more personal and professional goals includes an electronic communication device configured to run a lifestyle management and monitoring application, a server in communication with the electronic communication device for managing data related to the lifestyle management and monitoring application and a wireless communication channel enabling communication between the electronic communication devices and the server. The lifestyle management and monitoring application allows the users to form a personalized method to achieve the plurality of personal and professional goals by selecting and prioritizing the lifestyle, personal and professional development related tasks, monitoring the progress of each of the tasks over a period and providing feedbacks on the progress of each of the tasks through a dynamic graphical user interface of the lifestyle management and monitoring application.

### BACKGROUND OF THE INVENTION

### Field of the Invention

The present invention generally relates to systems and methods for assisting in personal and professional development of individuals. More specifically, the present invention relates to a system and application for assisting users to achieve personal and professional goals through management of lifestyle, personal and professional development related activities of the users.

### Background of the Invention

There are many people who have never been taught skills needed for success in today's competitive world. This is true whether that success is measured in monetary terms or in terms of personal satisfaction. It is proved that with proper personal improvement trainings and methods many people can progressively change their lifestyle to improve their personal and professional careers. These individuals would derive tremendous benefit from self-improvement curriculums that teach some of the skills needed for success. The individuals who would benefit from such curriculums range from those individuals who have never really entered the job market and whose self-esteem is non-existent to those individuals who have steadily climbed the ladder but are missing a key ingredient to climb to the next rung on the ladder. In addition, such a self-improvement curriculum for measuring and determining the amount of improvement in a person should allow individuals to determine their self-improvement.

The methods and systems that individuals use to implement a self-improvement program generally include books, recordings, seminars, and personal coaching. Books and recordings are the least expensive tools for people to acquire, but they are also the least personalized. Typically books and recordings provide only a single success formula for a mass-market and provide only limited user interactivity. Seminars are more expensive than books or recordings and generally do not provide personalization based on individual needs. However, they can provide some degree of interactivity with the presenter of the seminar, depending on the size of the audience. The most personalized and most expensive tool for self-improvement involves the engagement of a personal coach who can tailor a self-improvement program to individual needs and desires. This is akin to engaging a personal trainer for a weight management or exercise program to provide individualized lessons and coaching based on the client needs and skill level.

However with the advancement of computer and mobile technology, individuals can perform self-improvement exercises or activities using free or paid applications. Such applications also allow the individuals to monitor and review the progress of the activities with the help of a variety of data collected from the individuals during their activity. However all such existing applications forces the individuals to perform a preselected routine and measures the progress of these preselected routines. These routines are same for individuals with different types of preferences. Hence there exists a need for an application that would allow the users to plan and perform a variety of exercises selected by each user. The needed system and associated application would allow the users to monitor the progress of the exercises and to self-assess the level and effectiveness of performing the activities. There are many applications offering personal and professional development applications, however none of them has the above said features.

There are certain prior arts such as US 20070196798 A1 titled “Self-improvement system and method” filed by Innertalent Corporation discloses a self-improvement system that utilizes psychometric testing and personal development methodologies in a computer-based system, which is configured to provide a self-administered, automated self-improvement process. The system is configured to encourage a user to set goals and provides the user with tools to develop skills that are necessary for the realization of those goals. The system also substantively monitors the progress of a users development of those skills by utilizing user inputs received during the process and determining whether the user's views have changed as a result of the development process. However the above-discussed system wouldn't allow the users to monitor the progress of the exercises and to self-assess the level and effectiveness of performing the activities.

Another prior art US 20120089909 A1, titled “Goal management method and system” filed by Torin et. al. discloses systems and methods for integrating various platforms and streams, including social platforms and streams as well as networking, customer management, targeted marketing, and enterprise operations relating to the systems and methods to generate a set of goals. The method entails receiving user input that includes items and an input value associated with each of the items. Individual values are assigned to the items based on the input value. The individual values are then summed to generate a total value, and the items are ranked according to the contributions of their respective individual values to the total value. A difference between the total value and a corresponding reference value is determined. The input value that is associated with the highest-ranking item is changed, and the total value and the difference are then recalculated using the changed input value. However the above-discussed system wouldn't allow the users to monitor the progress of the exercises and to self-assess the level and effectiveness of performing the activities.

Hence, it can be seen that there is a need for a system and an application that would allow the users to plan and perform a variety of exercises selected by each individual users. The needed system and associated application would allow the users to monitor the progress of the exercises and to self-assess the level and effectiveness of performing the activities. There are many applications offering personal and professional development applications, however none of them has the above said features.

### SUMMARY

In view of the foregoing disadvantages inherent in the known types of systems like in the prior art, the present invention provides a system for enabling a number of users to manage a variety of lifestyle, personal and professional development related tasks to achieve their personal and professional goals. The system includes an electronic communication device configured to run a lifestyle management and monitoring application, a server in communication with the electronic communication device for managing a variety of data related to the lifestyle management and monitoring application and a wireless communication channel for enabling communication between the electronic communication devices and the server. The lifestyle management and monitoring application allows the users to form a personalized method to achieve the personal and professional goals by selecting and prioritizing the lifestyle, personal and professional development related tasks, monitoring the progress of each of the tasks over a period and providing feedbacks on the progress of each of the tasks through the dynamic graphical user interface of the lifestyle management and monitoring application.

A method to manage the lifestyle, personal and professional development related tasks to achieve the personal and professional goals of a user includes the steps of launching the lifestyle management and monitoring application from an electronic communication device, establishing communication between the lifestyle management and monitoring application and the server running a server side lifestyle management and monitoring application over the wireless communication channel, allowing the users to select the lifestyle, personal and professional development related tasks through a dynamic graphical user interface of the lifestyle management and monitoring application and allowing the users to prioritize and manage the lifestyle, personal and professional development related tasks through the dynamic graphical user interface of the lifestyle management and monitoring application. The present method also allows the users to monitor a progress of the lifestyle, personal and professional development related tasks in form of visual statistics of the lifestyle, personal and professional development related tasks performed by the user over a period of time. The statistics of the lifestyle, personal and professional development related tasks performed by the user over the period are visualized through the dynamic graphical user interface of the lifestyle management and monitoring application. The users are also allowed to provide feedbacks on the progress of each of the lifestyle, personal and professional development related tasks.

Accordingly, it is an object of the present invention to provide a system for enabling a number of users to manage a variety of lifestyle, personal and professional development related tasks to achieve their personal and professional goals.

Yet another objective of the present invention is to provide an electronic communication device configured to run a lifestyle management and monitoring application for enabling the users to manage the variety of lifestyle, personal and professional development related tasks to achieve their personal and professional goals.

A further objective of the present invention is to provide a lifestyle management and monitoring application to select and prioritize personalized lifestyle, personal and professional development related tasks to achieve their personal and professional goals.

Another objective of the present invention is to provide a lifestyle management and monitoring application to monitor progress of each of the personalized lifestyle, personal and professional development related tasks over a period.

Yet another objective of the present invention is to provide a lifestyle management and monitoring application to allow the users to perform self-assessment of the progress of each of the personalized lifestyle, personal and professional development related tasks for achieving the personal and professional goals of the user.

Another objective of the present invention is to provide a lifestyle management and monitoring smartphone application to manage a variety of lifestyle, personal and professional development related tasks to achieve personal and professional goals of the users.

Another objective of the present invention is to provide a lifestyle management and monitoring web application to manage a variety of lifestyle, personal and professional development related tasks to achieve personal and professional goals of the users.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 illustrates a block diagram showing the present system for enabling the users to manage their lifestyle, personal and professional development related tasks, according to a preferred embodiment of the present disclosure;

FIG. 2 is a block diagram showing the different components and modules of the electronic communication device running the lifestyle management and monitoring application, according to a preferred embodiment of the present invention;

FIG. 3 is a block diagram showing the different components and modules of the server in communication with the electronic communication device running the lifestyle management and monitoring application, according to a preferred embodiment of the present invention;

FIG. 4A represents a welcome page of the lifestyle management and monitoring application launched on the electronic communication device, according to an embodiment of the present disclosure;

FIG. 4B represents a sign up page of the lifestyle management and monitoring application launched on the electronic communication device, according to an embodiment of the present disclosure;

FIG. 4C represents a set up page of the lifestyle management and monitoring application launched on the electronic communication device, according to an embodiment of the present disclosure;

FIG. 4D represents a sub activities page of the lifestyle management and monitoring application launched on the electronic communication device, according to an embodiment of the present disclosure;

FIG. 4E represents an activity prioritizing page of the lifestyle management and monitoring application launched on the electronic communication device, according to an embodiment of the present disclosure;

FIG. 4F represents an activity selection page of the lifestyle management and monitoring application launched on the electronic communication device, according to an embodiment of the present disclosure;

FIG. 4G shows a homepage of the lifestyle management and monitoring application launched on the electronic communication device, according to an embodiment of the present disclosure;

FIG. 41H shows a motivational quote window of the lifestyle management and monitoring application launched on the electronic communication device, according to an embodiment of the present disclosure;

FIG. 41I shows a user activity or task page of the lifestyle management and monitoring application launched on the electronic communication device, according to an embodiment of the present disclosure;

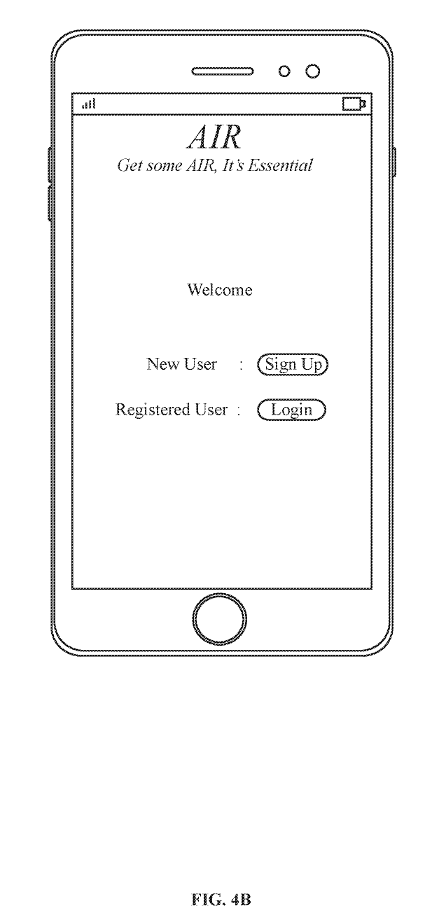

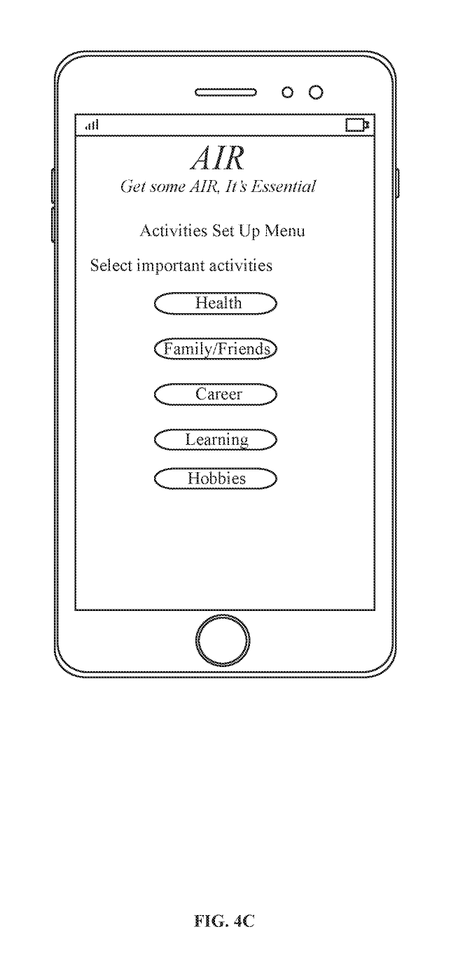

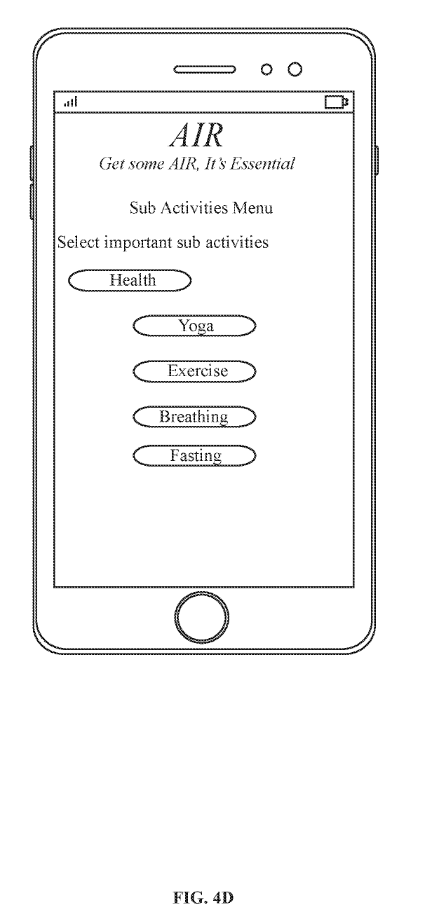

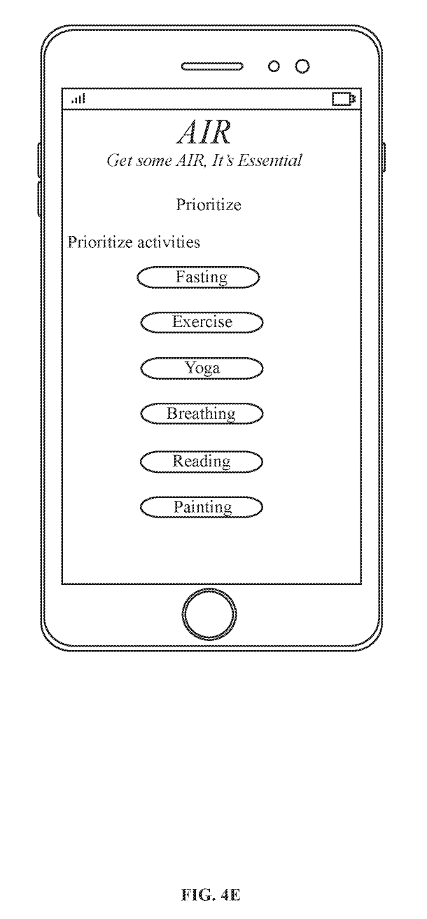

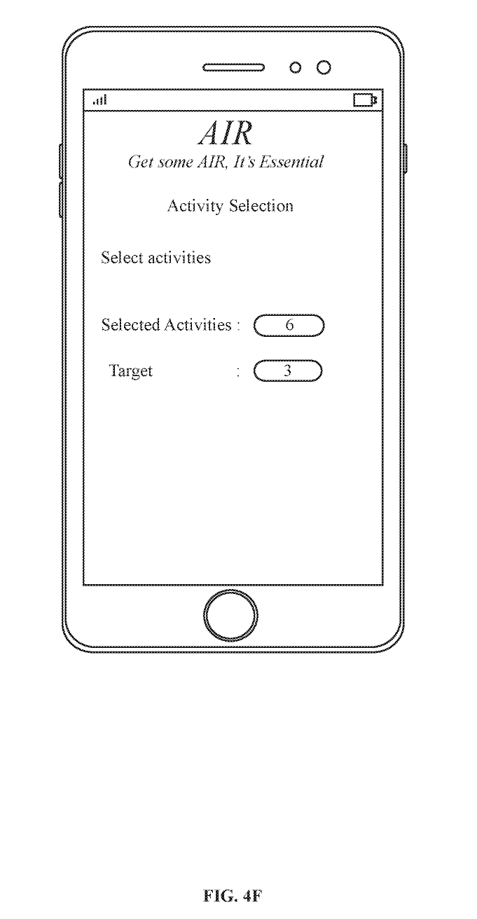

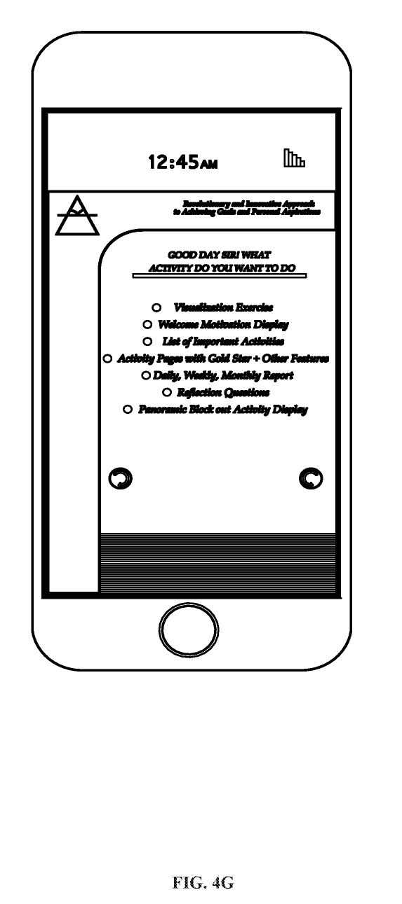

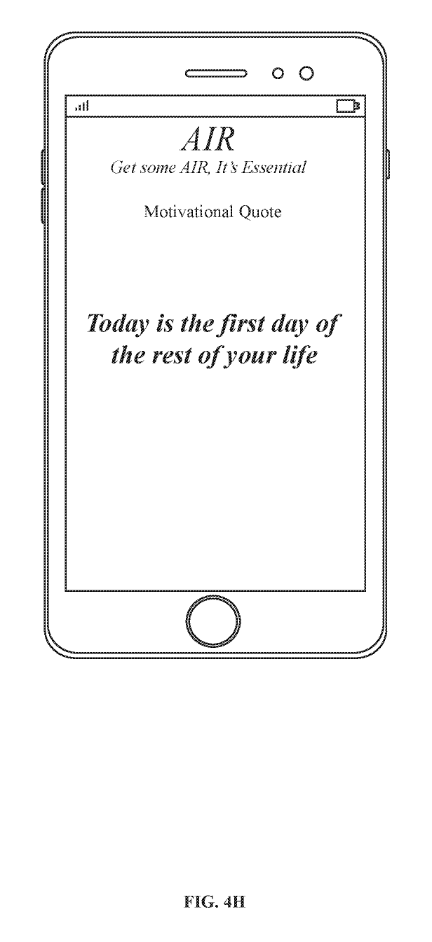

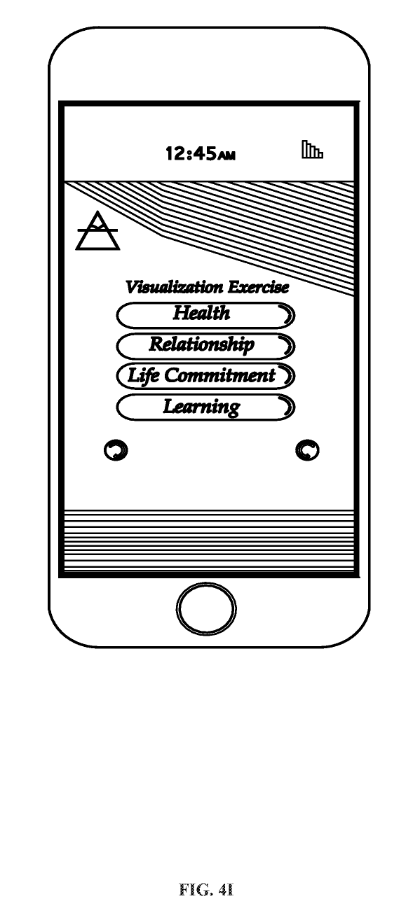

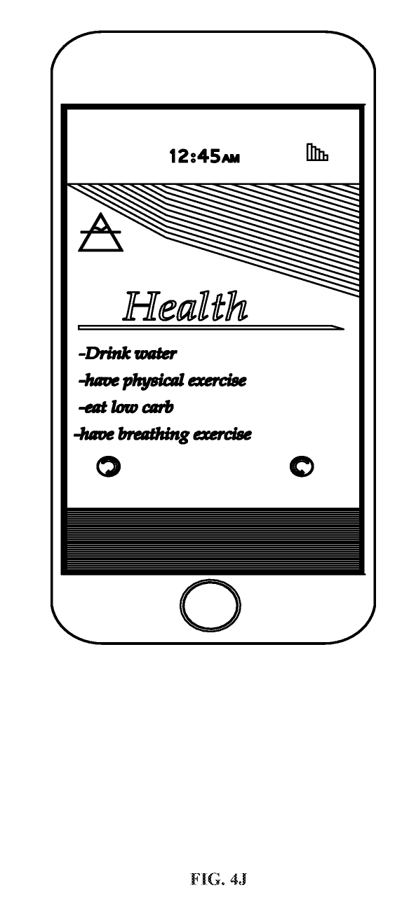

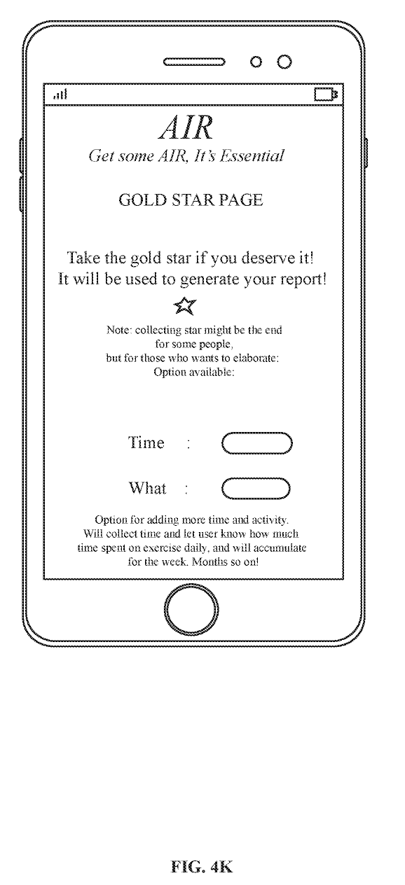

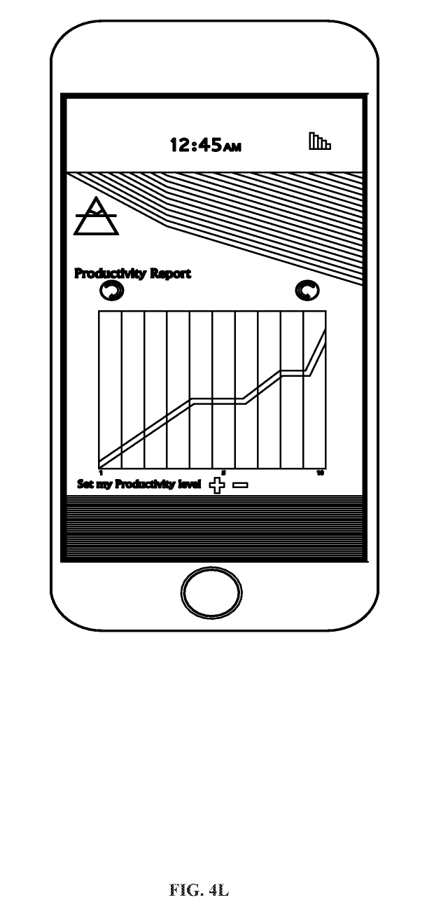

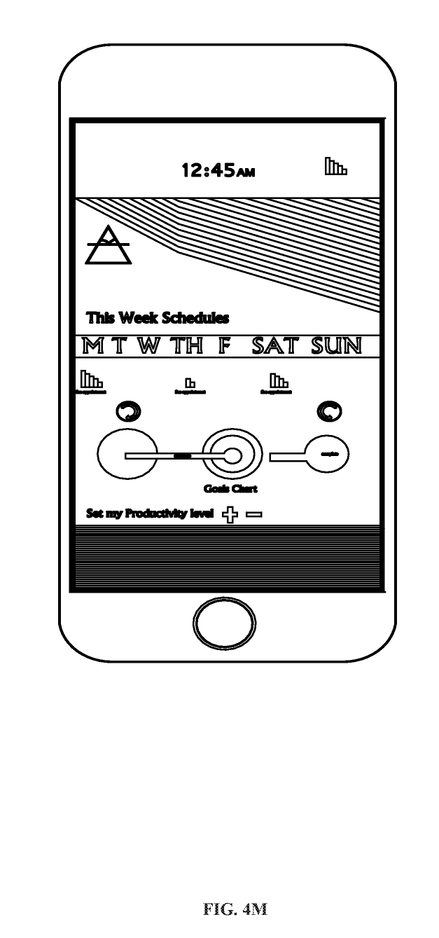

FIG. 4J shows the sub activities page accessed from the main activities page of the lifestyle management and monitoring application launched on the electronic communication device, according to an embodiment of the present disclosure;

FIG. 4K shows a method of setting gold start for a particular goal or activity through the lifestyle management and monitoring application launched on the electronic communication device, according to an embodiment of the present disclosure;

FIG. 4L shows the statistics or report page of the lifestyle management and monitoring application running on the electronic communication device, according to an embodiment of the present disclosure; and

FIG. 4M shows the weekly schedule of activities on the lifestyle management and monitoring application running on the electronic communication device, according to an embodiment of the present disclosure.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiment of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

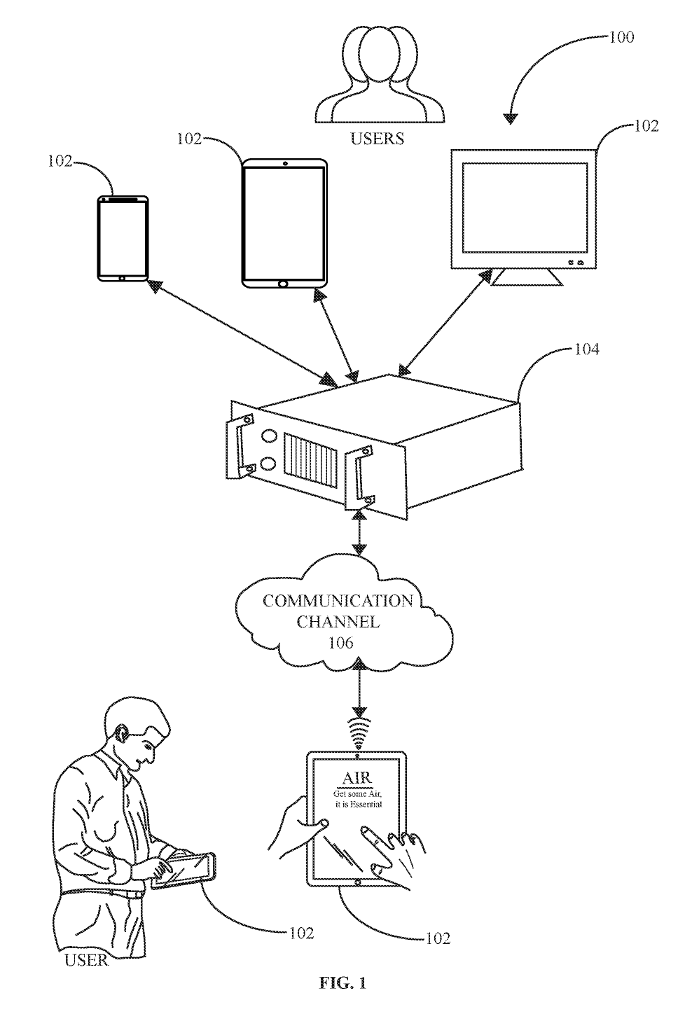

The present disclosure relates to a system for allowing a number of users to manage a variety of lifestyle, personal and professional development related tasks to achieve their personal and professional goals. FIG. 1 illustrates a block diagram showing the present system 100 for enabling the users to manage their lifestyle, personal and professional development related tasks, according to a preferred embodiment of the present invention. The present system 100 assists the users to achieve individual or personal goals and aspirations by managing each user's lifestyle, personal and professional development related tasks through an application. The present system 100 includes an electronic communication device 102 configured to run a lifestyle management and monitoring application for managing the variety of lifestyle, personal and professional development related tasks associated with each of the user. The system 100 further includes a server 104 in communication with the electronic communication device 102 for managing a variety of data associated with the lifestyle management and monitoring application. A wireless communication channel 106 enables the communication between the server 104 and the electronic communication devices 102 running the lifestyle management and monitoring application. The lifestyle management and monitoring application configured to run on the electronic communication devices 102 allows the users to set individual lifestyle, personal and professional development related tasks or goals through a dynamic graphical user interface of the lifestyle management and monitoring application. The lifestyle management and monitoring application further allows the users to prioritize each of the tasks and monitor progress of each of the tasks over a desired period of time. The present system 100 also allows the users to provide the plurality of scheduled feedbacks on the progress of each of the tasks through the dynamic graphical user interface of the lifestyle management and monitoring application.

In an embodiment, the lifestyle management and monitoring application associated with the system 100 allows the users to set their goals and aspirations in their life and assists the users to come up with the changes needed in their lifestyle, personal and professional activities to achieve the goals and aspirations within a specific period of time. The lifestyle management and monitoring application running on the electronic communication devices 102 allows the users to set the lifestyle, personal and professional development related tasks as day-to-day activities to achieve the goals and aspirations. In addition, the lifestyle management and monitoring application associated with the system 100 allows the users to prioritize individual lifestyle, personal and professional development related tasks or day-to-day activities based on the importance of each of the tasks. The lifestyle management and monitoring application running on the electronic communication devices 102 provides a variety of analysis reports or statistics related to the progress of each of the lifestyle, personal and professional development related tasks by the users through the dynamic graphical user interface.

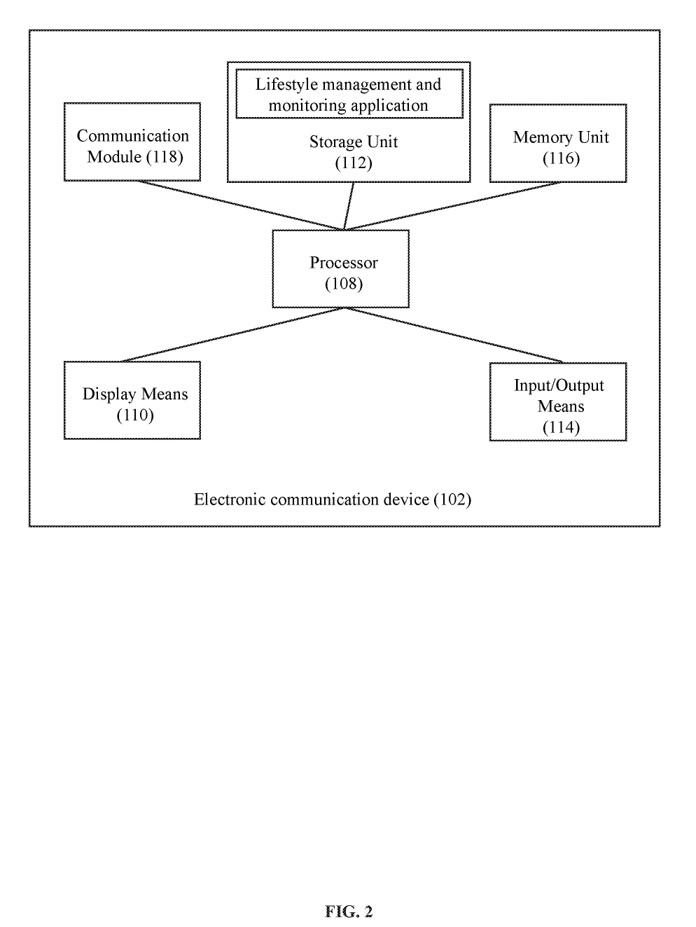

The hardware and software components of the present system 100 are discussed in detail below prior to disclosing the unique features and services offered by one or more embodiment of the present system 100. FIG. 2 is a block diagram showing the different components and modules of the electronic communication device 102 running the lifestyle management and monitoring application, according to a preferred embodiment of the present invention. The electronic communication device 102 can be smart devices such as, but not limited to, a smartphone, tablet, computer, smart wearable devices, and other smart devices connected to the Internet and capable of displaying a dynamic graphical user interface (GUI) of the lifestyle management and monitoring application. The electronic communication device 102 includes a processor 108 to process a number of instructions of the lifestyle management and monitoring application, a display means 110 for displaying the dynamic graphical user interface of the lifestyle management and monitoring application, a storage unit 112 for storing a variety of data associated with the lifestyle management and monitoring application, an input/output means 114 for allowing the users to interact with the dynamic graphical user interface of the lifestyle management and monitoring application, a memory unit 116 for temporarily storing the data and instructions associated with the lifestyle management and monitoring application while performing a number of operations by the processor 108 and a communication module 118 to enable communication between the electronic communication devices 102 and the server 104 via the wireless communication channel 106. The users are allowed to interact with the contents of the lifestyle management and monitoring application through the dynamic graphical user interface using the input/output means 114. For instance, the users are allowed to interact with the contents presented on the dynamic graphical user interface of the lifestyle management and monitoring application using a keyboard, pointing device such as a mouse, at least one gesture or touch, voice activation, or any other interacting means. The lifestyle management and monitoring application includes an optional feature that allows the electronic communication devices 102 to launch a camera module to capture the contents including images and videos and store the captured contents in the lifestyle management and monitoring application. Further, the input/output means 114 allows the users to provide feedbacks to the lifestyle, personal and professional development related tasks performed by the user through the dynamic graphical user interface of the lifestyle management and monitoring application.

The processor 108 associated with the electronic communication device 102 processes a number of instructions of the lifestyle management and monitoring application to allow the users to prioritize, manage and monitor progress of the preset lifestyle, personal and professional development related tasks by the user. The processor 108 further executes the instructions of the lifestyle management and monitoring application to allow the user to provide feedbacks on the progress of each of the tasks performed by the user. In a preferred embodiment of the present invention, the display means 110 is a touchscreen display and is capable of displaying a dynamic graphical user interface of the lifestyle management and monitoring application to allow the users to view and set the plurality of lifestyle, personal and professional development related tasks and provide feedbacks on the progress of each of the tasks performed by the user using gestures or touch.

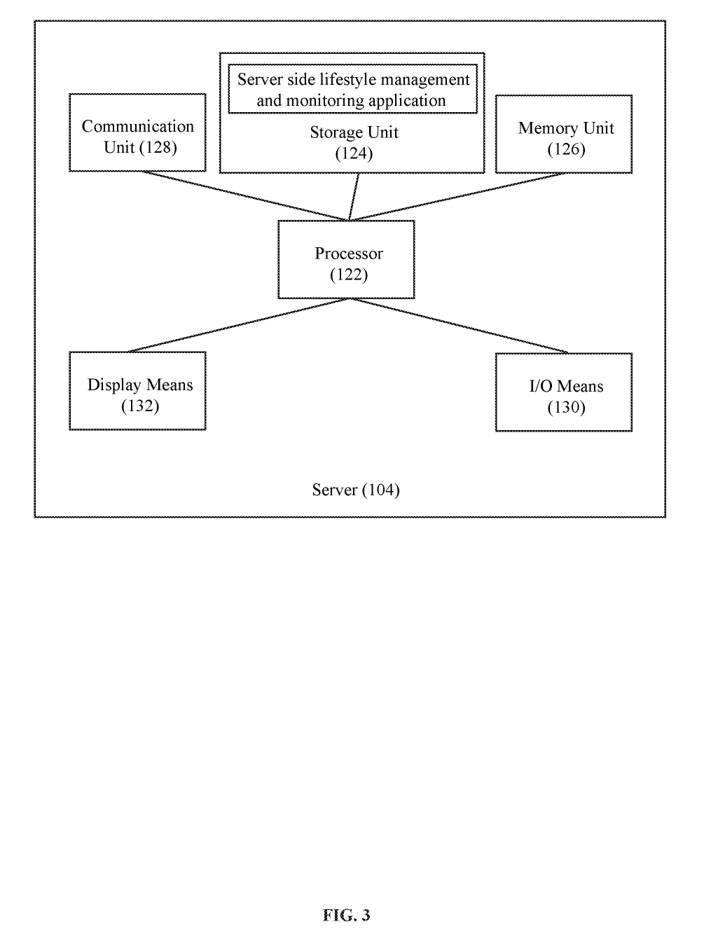

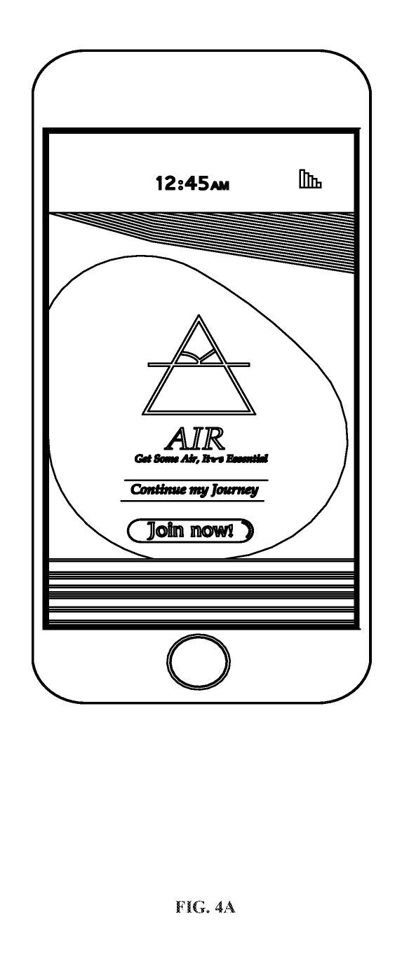

According to a preferred embodiment of the present system 100, all the communication between the lifestyle management and monitoring application running on the electronic communication devices 102 of the users and the server 104 are performed over the wireless communication channel 106. The server 104 can be a physical server 104 located at one or more locations or a central cloud server 104 offering services to the users via the lifestyle management and monitoring application connected to the central cloud server 104. FIG. 3 is a block diagram showing the different components and modules of the server 104 in communication with the electronic communication device 102 running the lifestyle management and monitoring application, according to a preferred embodiment of the present invention. The server 104 includes similar components as any normal server or a computer, which includes a processor 122, a storage unit 124, a memory unit 126, a communication unit 128, an input/output (I/O) means 130 and a display means 132. The server 104 is in communication with the electronic communication devices 102 in real-time over the Internet enabled by the communication unit 128. In some instances, the server 104 is installed with a server side lifestyle management and monitoring application configured to manage the operations of the lifestyle management and monitoring application running on the electronic communication devices 102. The sever side lifestyle management and monitoring application is stored in the storage unit 124 and the processor 122, when required, executes the instructions of the application to perform a number of tasks including user management, tasks management etc. The memory unit 126 stores the data associated with the sever side lifestyle management and monitoring application when the processor 122 executes the instructions of the application. The sever side lifestyle management and monitoring application includes a user management module that handles all the information related to the user registration and all other user related activities performed by the users through the dynamic graphical user interface of the lifestyle management and monitoring application running on their electronic communication devices 102. The sever side lifestyle management and monitoring application running on the server 104 further includes a content management module that receives and temporarily or permanently stores the contents to received from or presented through the dynamic graphical user interface of the lifestyle management and monitoring application running on the electronic communication devices 102. The content management module manages the contents including the lifestyle, personal and professional development related tasks and the feedbacks from the users provided through the lifestyle management and monitoring application running on the electronic communication devices 102.

The users can download the lifestyle management and monitoring application from Internet sources including, but not limited to, iTunes store or App store, Google play store and many other software stores and install the application in their electronic communication devices 102 such as Smartphones. In some instance, different versions of the lifestyle management and monitoring application are available from the Internet sources, which includes a web application, computer software application and a smart device application, each version is configured to optimally run on different electronic communication devices 102 such as tablet, computer, smartphone, smart wearable devices etc., and the users can select and download the desired versions of the lifestyle management and monitoring application into their electronic communication device 102. After downloading and installing the lifestyle management and monitoring application, the users can launch the application from the electronic communication device 102 and view the dynamic graphical user interface, which allows the users to perform a number of tasks such as, but not limited to, user registration, set and prioritize the lifestyle, personal and professional development related tasks, etc.

FIG. 4A to FIG. 4D represents the illustrative dynamic graphical user interfaces of the lifestyle management and monitoring application running on the electronic communication device 102, according to one or more embodiment of the present invention. However, the design of the dynamic graphical user interface of the lifestyle management and monitoring application may differ from the sample illustrations shown in FIG. 4A to FIG. 4D. FIG. 4A represents a welcome page of the lifestyle management and monitoring application launched on the electronic communication device 102, according to an embodiment of the present disclosure. FIG. 4B represents a sign up page of the lifestyle management and monitoring application launched on the electronic communication device 102, according to an embodiment of the present disclosure. The sign up page of the lifestyle management and monitoring application prompts the new users to register into the application and prompts the existing users to log into the application using unique credentials provided to the existing users. FIG. 4C represents a set up page of the lifestyle management and monitoring application launched on the electronic communication device 102, according to an embodiment of the present disclosure. The set up page of the lifestyle management and monitoring application prompts the users to enter their lifestyle, personal and professional preferences, which includes health, family and friends related preferences information, career preferences, hobbies, goals etc. The users can select desired categories from the list shown on the dynamic graphical user interface of the lifestyle management and monitoring application and in each of the activity selection, the user can further select a number of other sub activities as shown in FIG. 4D. Also the lifestyle management and monitoring application provides option for user defined activities or tasks for people who want to customize their own stuff. Once the user selects all the desired categories of lifestyle, personal and professional development tasks, the lifestyle management and monitoring application allows the users to prioritize or rearrange the categories as shown in FIG. 4E. The users can select any number of activities or tasks and can opt to perform all or a part of the selected activates in a day as shown in FIG. 4F. For example, if the user picked x number of activities or tasks, and the applications allows the user to enter the number of tasks going to performed in one day, i.e. y. Further the application allows the users to set suitable time of the day at which they want to receive notifications to view the reports or statistics and to answer the feedback questions through the dynamic graphical user interface as pop up windows.

FIG. 4G shows a homepage of the lifestyle management and monitoring application launched on the electronic communication device 102, according to an embodiment of the present disclosure. The homepage pops up a motivational quote, which is set for a particular period such as, same quote for a whole week, which may change later. The server 104 can generate the motivational quotes automatically or the user can enter the motivational quotes to be displayed through the homepage of the lifestyle management and monitoring application. The motivational quotes may include text, images or video, related to contents such as for e.g. “Today is the first day of the rest of your life”, “A man can fail many times, but he isn't a failure until he begins to blame somebody else.”, “It's okay if you go slow and rest is good, as long as you don't quit.”, etc. The user can then tap the touchscreen display to see the main page of the lifestyle management and monitoring application as shown in FIG. 4H. From the main page the user can select and go to the desired activity or task page as in FIG. 4I. From the main activity page, the user can visit the sub activities page by selecting a desired activity from the main activity page as in FIG. 4J.

From the provided list of activities or tasks, the user can rearrange or prioritize the list of activities. For example, if the user has exercise on the list, as in FIG. 4D, the user can click on the exercise tab to launch a full screen window on the dynamic graphical user interface of the lifestyle management and monitoring application. The user can set a gold start for that particular goal or activity or task from the dynamic graphical user interface and the user takes the star and this forms a base to generate statistics, as in FIG. 4K. The activities can be done with a friend, so the user can complete two activities or tasks on the list including health and cultivating relationship. The user can enter the following details such as time and type of activity through the dynamic graphical user interface and provide pictures or videos or text through the dynamic graphical user interface of the lifestyle management and monitoring application. The dynamic graphical user interface of the lifestyle management and monitoring application further allows the users to record video or audio during the activity. The users can personalize the contents such as pictures or videos or text using built-in fonts, picture or frame editing tools associated with the lifestyle management and monitoring application. Once the user submits all the data including the pictures or videos, the lifestyle management and monitoring application generate a beautiful display where pictures can be moved around and the activities can be in like little boxes that can be moved around thereby creating a dynamic, personalized user interface for each user. The user can set his/her own screen for each of the activity page, e.g. eating healthy, catching up with a friend etc., displayed through the dynamic graphical user interface of the lifestyle management and monitoring application.

FIG. 4L shows the statistics or report page of the lifestyle management and monitoring application running on the electronic communication device 102. The dynamic graphical user interface of the lifestyle management and monitoring application presents activity or task progress reports on daily, weekly, monthly, yearly and at any selected duration basis. The user can also present, during set up, the time and type of statistics they want to see and the time of notification. Also the user can change this time at any time on a settings page of the lifestyle management and monitoring application. Further the user can increase or decrease the productivity level using controls provided on the dynamic graphical user interface of the lifestyle management and monitoring application.

In case of daily statistics, for example, if the user selected six activities and want to complete at least three per day, he/she is marked as performed 100% of the activity if he/she performs the minimum amount of activity, i.e. three. If the user performs three tasks or activities on a day so the user get 100% completion status for the day. The statistics is calculated based on what the user had preset and what he/she actually going to do. When the user collect the star from the lifestyle management and monitoring application, the statistics takes the action as a ‘yes’ and uses it to generate the statistics. If the user performs two things or tasks or activities on a day so user gets 66% completion status and if a user performs five things or tasks or activities on a day, he/she gets 100% completion status. However, the extra activity or tasks performed on that day will be reflected in another statistics, where it is shown as extra percentage due to additional activity. The statistics notification pops up on the lifestyle management and monitoring application at the same time and user can view the statistics of the activities or tasks performed on the particular day. The lifestyle management and monitoring application also provides options to not get notification or change time of receiving notifications. The report page showing the statistics of the activities or tasks performed on the particular day is visually presented through the dynamic graphical user interface of the lifestyle management and monitoring application.

In case of weekly statistics, for example, if the user performs three of the same activities or tasks everyday, he/she gets a 100% completion rate for weekly statistics. If the user only performs three type of activities instead of three of the same activities or tasks everyday, he/she gets a 50% completion rate for weekly statistics. The statistics shows the number of times the user performed an activity or task, for example, if the user exercise everyday, the application shows that the activity is performed seven times during the week and if the user puts in the time and activity type, those details are also displayed through the weekly statistics page of the lifestyle management and monitoring application. In another instance, if the user performs three activities or tasks every day of a week and completes every activity at least once, then the user gets 100% completion status for weekly statistics, and also gets 100% completion status for getting to all of the activities at least once.

Further the users can provide monthly statistics through the dynamic graphical user interface of the lifestyle management and monitoring application. For example, if the user performs three activities every day and performs all the activities at least once. then the user gets 100% completion status for monthly statistics. If the user performs two to three activities over the month, and performs all the activities at least once, then the user gets 100% completion status for monthly statistics, whereas in daily and weekly statistics, the user might not get 100%, completion status. Al the daily, weekly and monthly and beyond statistics are accompanied by separate sets of feedback questionnaire.

The users can provide feedback to the progress of each of the activities through the dynamic graphical user interface of the lifestyle management and monitoring application. The users can launch the feedback page from the statistics page of the lifestyle management and monitoring application using a flip or any kind of preset gesture. The user can answer for questions such as, for example, ‘How do you feel about your achievement?’ in form of text or voice recording. Further the users can edit the activity list or can continue with the same activity list with the same priority for the coming sessions. The users can set additional activity or tasks and add that to the activity list to perform more activities or tasks and to achieve the set goal at a faster rate.

FIG. 4M shows the weekly schedule of activities on the lifestyle management and monitoring application running on the electronic communication device 102. Another feature of the lifestyle management and monitoring application includes a block out progress view of the completed activities by the user. The block out progress view of the completed activities allows the users to see a panoramic view of the statistics, where the user can choose to view weekly, monthly, quarterly statistics etc. This view allows the users to see and realize how far they've come and how was the difficulty during the beginning, and how he/she overcame it by persistence. Even if user misses a bunch of activities during the above period, block out progress view of the completed activities allows the users to see how far they've come. User can export high quality charts and can print or share the panoramic view of the statistics displayed on the dynamic graphical user interface of the lifestyle management and monitoring application.

The present system 100 and associated lifestyle management and monitoring application allows the users to select a number of activities or tasks, which are important for them to achieve their personal and professional development and goals, and enables the users to decide the extend to which he/she wants to achieve or complete the preset or preselected personal and professional development and goals through the lifestyle management and monitoring application. Further the lifestyle management and monitoring application allows the users to visualize the statistics, showing the progress of the activities or the tasks, for a selected duration or period such as daily, weekly, monthly, yearly or for any desired period of time. Further the lifestyle management and monitoring application allows the users to provide feedbacks by answering a number of preset questions or reflection questions, which are provided to measure the satisfaction of the user after performing the preselected activities or the tasks. The present lifestyle management and monitoring application allows the users to individually set their lifestyle, personal and professional development goals and provides assistance to achieve the goals by assisting the users to complete the tasks or the activities. The present lifestyle management and monitoring application allows the users to personalize their personal and professional development as much as or as little as they want.

Further, it should be noted that the steps described in the method of use can be carried out in many different orders according to user preference. The use of “step of should not be interpreted as “step for”, in the claims herein and is not intended to invoke the provisions of 35 U.S.C. § 112, paragraph 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A system for enabling a plurality of users to manage a plurality of lifestyle, personal and professional development related tasks to achieve a plurality of personal and professional goals comprising:
an electronic communication device configured to run a lifestyle management and monitoring application;
wherein the electronic communication device includes:
a processor to process a plurality of instructions of the lifestyle management and monitoring application to allow the users to:
select and prioritize the plurality of lifestyle, personal and professional development related tasks;
manage and monitor a progress of the plurality of lifestyle, personal and professional development related tasks; and
provide a plurality of feedbacks on the progress of each of the tasks;
a storage means to store the lifestyle management and monitoring application; and
a display means to display a dynamic graphical user interface of the lifestyle management and monitoring application to allow the users to view and set the plurality of lifestyle, personal and professional development related tasks and to provide the feedbacks on the progress of each of the tasks;
at least one server in communication with the electronic communication device for managing a plurality of data related to the lifestyle management and monitoring application; and
a wireless communication channel for enabling communication between the electronic communication devices and the server;
characterized in that the lifestyle management and monitoring application allows the users to form a personalized method to achieve the plurality of personal and professional goals by selecting and prioritizing the plurality of lifestyle, personal and professional development related tasks, monitoring the progress of each of the tasks over a period and providing the plurality of feedbacks on the progress of each of the tasks through the dynamic graphical user interface of the lifestyle management and monitoring application.

2. The system of claim 1 wherein the electronic communication device is selected from a group consisting of smartphones, tablets, smart wearable devices, computers, and other smart devices capable of running the lifestyle management and monitoring application.

3. The system of claim 1 wherein the lifestyle management and monitoring application is provided in form a web application, computer software application and a smart device application configured to run on the plurality of electronic communication devices.

4. The system of claim 1 wherein the processor processes the plurality of instructions of the lifestyle management and monitoring application to:
allow the users to select the lifestyle, personal and professional development related tasks through the dynamic graphical user interface;
prioritize the lifestyle, personal and professional development related tasks through the dynamic graphical user interface;
monitor the progress of each of the lifestyle, personal and professional development related tasks through the dynamic graphical user interface; and
provide the plurality of feedbacks on the progress of each of the lifestyle, personal and professional development related tasks through the dynamic graphical user interface.

5. The system of claim 1 wherein the lifestyle management and monitoring application allows the users to provide a plurality of inputs in form of voice, a plurality of gestures on the display means and through an input device selected from a group consisting of keyboards, touchpads and other electronic input devices.

6. The system of claim 1 wherein the display means is a touchscreen display capable of interactively displaying the dynamic graphical user interface of the lifestyle management and monitoring application.

7. The system of claim 1 wherein the lifestyle management and monitoring application running on the electronic communication device is capable of interacting with a plurality of external applications including a plurality of activity tracking and task management applications.

8. The system of claim 1 wherein the server includes a server side lifestyle management and monitoring application in communication with the lifestyle management and monitoring application running on the electronic communication devices to manage a plurality of information including a plurality of user information and task related information.

9. The system of claim 1 wherein the lifestyle management and monitoring application allows the users to view progress of each of the lifestyle, personal and professional development related tasks over the period through the dynamic graphical user interface.

10. The system of claim 8 wherein the lifestyle management and monitoring application running on the electronic communication device provides a dynamic, panoramic and interactive view of the plurality of information including a plurality of statistics of the activities performed by the user over the period.

11. The system of claim 10 wherein the lifestyle management and monitoring application running on the electronic communication device allows the users to save, print, share the plurality of statistics through the plurality of external applications including social networking applications.

12. A computer readable storage means having embodied thereon a lifestyle management and monitoring application, the lifestyle management and monitoring application being executable by a processor to perform a method to manage a plurality of lifestyle, personal and professional development related tasks to achieve a plurality of personal and professional goals, the method comprising:
launching the lifestyle management and monitoring application from an electronic communication device;
establishing communication between the lifestyle management and monitoring application and a server running a server side lifestyle management and monitoring application over a wireless communication channel;
allowing the users to select the plurality of lifestyle, personal and professional development related tasks through a dynamic graphical user interface of the lifestyle management and monitoring application;
allowing the users to prioritize and manage the plurality of lifestyle, personal and professional development related tasks through a dynamic graphical user interface of the lifestyle management and monitoring application;
allowing the users to monitor a progress of the plurality of lifestyle, personal and professional development related tasks in form of at least one statistics of the lifestyle, personal and professional development related tasks performed by the user over a period,
wherein the statistics of the lifestyle, personal and professional development related tasks performed by the user over the period are visualized through the dynamic graphical user interface; and
allowing the users to provide a plurality of feedbacks on the progress of each of the lifestyle, personal and professional development related tasks.

13. The computer readable storage means of claim 12 wherein the lifestyle management and monitoring application allows the users to personalize the lifestyle, personal and professional development related tasks performed over the period to achieve the personal and professional goals.
